(19) United States
(12) Patent Application Publication
(10) Pub. No.: US 2024/0377231 A1
(43) Pub. Date: Nov. 14, 2024

(54) Method for Operating a Magnetic-Inductive Flowmeter and Corresponding Magnetic-Inductive Flowmeter

(71) Applicant: KROHNE Messtechnik GmbH, Duisburg (DE)

(72) Inventor: Michael Vogt, Bochum (DE)

(21) Appl. No.: 18/661,122

(22) Filed: May 10, 2024

(30) Foreign Application Priority Data
May 12, 2023 (DE) 10 2023 112 637.7

(51) Int. Cl. G01F 1/58

(52) U.S. Cl. CPC G01F 1/584; G01F 1/586

(57) ABSTRACT

A magnetic-inductive flowmeter and a method for operating the flowmeter are disclosed. The flowmeter includes: a measuring tube for guiding an electrically conductive medium; magnetic field devices which can be energized separately with excitation currents for generating at least one magnetic field passing through the measuring tube; measuring electrodes for capturing a measuring voltages induced in the medium; and a control and evaluation unit for generating the magnetic field by energizing at least one of the magnetic field devices and for calculating the volume flow of the medium through the measuring tube. The method includes: applying excitation currents to the magnetic field devices; capturing measurement voltages; and determining flow-dependent transfer factors from the excitation currents and the measurement voltages caused by the excitation currents; and calculating the volume flow of the medium from the transfer factors.

### TECHNICAL FIELD

The invention relates to a method for operating a magnetic-inductive flowmeter, with a measuring tube for conducting an electrically conductive medium, with a plurality of magnetic field devices which can be energized separately with excitation currents for generating at least one magnetic field passing through the measuring tube at least partially perpendicular to the direction of flow of the medium, with a plurality of measuring electrodes for capturing a plurality of measuring voltages induced in the medium, and with a control and evaluation unit for generating the magnetic field by energizing at least one of the magnetic field devices and for calculating the volume flow of the medium through the measuring tube. In addition, the invention also relates to a corresponding magnetic-inductive flowmeter.

### BACKGROUND

Magnetic-inductive flowmeters of the aforementioned type and corresponding methods for operating these magnetic-inductive flowmeters have been known for a long time. The measuring principle is based on the action of force on moving charge carriers in a magnetic field, wherein the action of force is proportional to the speed of the charge carriers. The separation of the charge carriers in the electrically conductive medium induces an electrical voltage in the medium that is dependent on the flow velocity, which is then tapped using measuring electrodes. In the state of the art, the induced measuring voltage is used directly to determine the flow velocity-averaged over the flow cross-section—and thus the volume flow of the conductive medium through the measuring tube.

Many magnetic-inductive flowmeters only work with a single magnetic field device and usually with only one pair of measuring electrodes to capture the induced voltage. However, it is also known to use several magnetic field devices and several measuring electrodes or pairs of measuring electrodes, wherein the magnetic field devices are then energized sequentially, i.e. one after the other, and corresponding induced measuring voltages are recorded one after the other. Finally, the volume flow is calculated directly as a function of the captured measuring voltages.

Magnetic-inductive flowmeters are sensitive to changes in the flow profile. A change in the flow profile can be caused by the flow itself (for example during the transition from laminar to turbulent flow, i.e. depending on the Reynolds number), but the change in the flow profile can also be caused by external influences, for example by an unfavorable installation situation of the magnetic-inductive flowmeter, such as when the magnetic-inductive flowmeter is arranged immediately after the bend of a pipe system, resulting in a completely asymmetrical flow profile.

To describe the field-theoretical relationships between point-wise tapped measuring voltages, the magnetic field distribution in the relevant volume of the measuring tube, the velocity distribution of the medium (flow profile) and the resulting induced electric field distribution, systematic considerations have been made by Shercliff (and others), from which the concept of the so-called weight function has emerged. To physically describe the processes in a magnetic-inductive flowmeter, the electrode voltage is calculated using a volume integral over the interior of the magnetic-inductive flowmeter; the integrand is the scalar product of the said weight function and the velocity field of the flow. The position-dependent weight function therefore describes the extent to which different flow elements in the volume of the magnetic-inductive flowmeter contribute to the measurement voltage. The more variable the weight function is, the more sensitive the flow measurement is to a change in the flow profile. The description of the relationships quickly becomes complex and can only be solved conclusively for idealized assumptions regarding the measuring tube geometries, the arrangement of measuring electrodes and the magnetic field distribution. In any case, the weight function approach makes it clear that velocity components distributed over the flow cross-section or the flow volume make different contributions to the induced measurement voltage, so that different velocity profiles can lead to different measurement voltages with the same averaged volume flow rate.

### SUMMARY

The object of the present invention is to provide a method for operating a magnetic-inductive flowmeter and such a magnetic-inductive flowmeter in which the flow measurement has a lower dependence on the flow profile of the electrically conductive medium.

The object derived above is achieved in the method described at the beginning for operating a magnetic-inductive flowmeter by applying a plurality of excitation currents to a plurality of magnetic field devices, capturing a plurality of measurement voltages and determining a plurality of flow-dependent transmission factors from the excitation currents and the measurement voltages caused by the excitation currents. A transmission factor is the ratio of the proportion of a measurement voltage caused by an excitation current to the level of this excitation current. The volume flow of the medium is then calculated from a plurality of the determined transmission factors.

The method according to the invention provides a considerable gain in information about the physical relationships in the magnetic-inductive flowmeter and about the flow situation in the measuring tube, at least compared to the evaluation of the measuring voltages for determining the volume flow. When referring to a plurality of magnetic field devices to which a plurality of excitation currents are applied, it is meant that the different magnetic field devices also generate differently oriented magnetic fields in the measuring tube. The same applies to the understanding of the multiple measurement voltages captured by the plurality of measuring electrodes, which are measured along differently oriented measurement paths within the measuring tube, wherein a measurement path is essentially determined by the imaginary connecting line between the measuring electrodes involved in the measurement.

If, for example, it is assumed that there are three magnetic field devices to which three separately adjustable excitation currents are applied and that two measuring voltages are captured, then two measuring voltages would be available in the conventional determination of the volume flow of the medium, in which the flow information is reflected. In the method according to the invention, however, the flow information is reflected in 3*2 of the flow-dependent transfer factors, which also support flow information but have a significantly higher resolution than the two recorded measurement voltages. With the method according to the invention, practically six correlations can be used in the example, while with the conventional method there are only two. If U1 and U2 are the measurement voltages and I1, I2, I3 are the excitation currents of the magnetic field devices, then the equational relationship is as follows (equation 1):

$$U 1 = K 11 * I 1 + K 12 * I 2 + K 13 * I 3$$

$$U 2 = K 21 * I 1 + K 22 * I 2 + K 23 * I 3$$

In more general terms, with n excitation currents of the magnetic field devices and with m measurement voltages, there are a total of m*n transfer factors K and thus m*n interactions. In matrix notation, the following then applies (equation 2):

$$U = K * I .$$

U is a column vector with m measured voltages U1, . . . , Um; I is a column vector with the components I1, . . . , In; K is an m*n matrix with the elements K11, . . . , Kmn. In the following, a simple capital letter is considered a vector or matrix to simplify the notation. If a letter (or a sequence of letters) is followed by a number or a general counting index (i, j) (for example I2, Ij, Kmn), then these are understood to be corresponding scalar values.

The transfer factors therefore indicate the extent to which an excitation current affects a determined measurement voltage. This relationship depends on the geometric conditions in the implementation of the magnetic-inductive flowmeter, in particular what kind of magnetic field a certain excitation current generates and how the measuring electrodes are arranged in relation to the magnetic field. For example, if a measuring voltage is recorded with measuring electrodes arranged along a magnetic field line, then the excitation current generating the magnetic field has practically no influence on the measuring voltage recorded by these electrodes. However, the same current has a considerable influence on a measurement voltage that is recorded with measuring electrodes arranged perpendicular to the course of the magnetic field. The corresponding transmission factor will therefore naturally be quite large. The example makes it clear that the transmission factors characterize the relationships in certain spatial areas or flow cross-sections within the measuring tube of the magnetic-inductive measuring device.

However, the transfer factor is not only dependent on the geometry and the field characteristics, but also on the (local) volume flow rate and flow profile prevailing at the time of measurement. It is perfectly obvious that the contribution of a magnetic field exciting current to a measurement voltage is naturally greater if there is a high flow velocity and correspondingly greater charge separation.

In principle, the flow-dependent transfer factors Kij of the transfer factor matrix K must therefore be determined according to equation 2 after a measurement has been carried out so that the transfer factors can then be included in the calculation of the volume flow. By skillfully using the transfer factors to determine the volume flow, the sensitivity of the measurement with regard to a change in the flow profile can be significantly reduced, thus increasing the measurement accuracy. If one remains with the idea of the weight functions explained at the beginning, then the combination or superposition of the transfer factors in the calculation of the volume flow practically represents a superposition of different weight functions, the superposition of which has a greater uniformity or uniformity over the measuring cross-section of the measuring tube, so that the sensitivity to the change in the flow profile is reduced. It can be seen from the explanations that the method is particularly advantageous if more transmission factors are determined than measurement voltages (along different measurement paths) have been captured, and if more transmission factors are used to calculate the volume flow than measurement voltages have been captured. In this case, there is a clear gain in information compared to the known use of measured voltages alone.

In a preferred design of the method, it is provided that several of the plurality of magnetic field devices are simultaneously subjected to a plurality of excitation currents. The advantage of this procedure lies primarily in the improvement of the signal-to-noise ratio, as the induced measurement voltages depend on the strength of the excited magnetic field or the excited magnetic fields of the multiple magnetic field devices. Overall, care must be taken to ensure that the magnetic field devices are operated in a linear range and do not saturate.

A preferred design of the method is characterized in that the volume flow of the medium is calculated from a linear combination of several of the flow-dependent transfer factors, wherein, in particular, the transfer factors Kij are weighted by weighting factors Wij (equation 3):

$$\dot{V} = {\sum }_{i = 1}^{m} {\sum }_{j = 1}^{n} Wij * Kij$$

The weighting factors Wij, for example, are selected in such a way that the measurement error is minimized, especially when the flow profile changes. For this purpose, calibration measurements can be performed with a varying but known volume flow rate. In order to determine the most suitable choice of linear relationship and/or weighting factors, the weighting factors and relationships can be determined by optimization methods, for example by a Monte Carlo simulation (random variation of the weighting factors), also in combination with a gradient method for error minimization. Instead of calibration measurements, the entire system, i.e. the magnetic-inductive flowmeter with the multiple magnetic field devices and the multiple captured induced measurement voltages, can also be simulated using a corresponding numerical method (finite element method, boundary element method, etc.). By solving an optimization task accordingly using the numerical model, linear combinations of several transmission factors with suitable weighting can then be determined in order to minimize a measurement error and the dependence on changed flow profiles.

In an alternative design of the method, the volume flow of the medium is calculated using a non-linear function in several of the flow-dependent transfer factors, wherein the transfer factors in the non-linear function are weighted by weighting factors. The design strategies described above for the linear case can also be used here (equation 4; i, j run from 1 to m or from 1 to n):

\dot{V}=f(Kij)

As previously mentioned, the shape of the flow profile depends on the Reynolds number, which is proportional to the volume flow rate and inversely proportional to the (kinematic) viscosity v. For this reason, the remaining non-linearity error when calculating the volume flow, which is also given when using multiple magnetic field devices and/or capturing multiple measurement voltages, changes when using a non-linear relationship (equation 4) as the (kinematic) viscosity (of the flowing fluid) changes. To overcome this problem, in a preferred design of the method, normalized transfer factors are first calculated using the known or measured (kinematic) viscosity v of the medium (equation 5):

$$K ij , norm = Kij / v$$

In a further step, the normalized transfer factors Kij, norm are mapped non-linearly using a non-linear function g to an estimated value for a (total) Reynolds number. Finally, the volume flow rate is estimated from this, taking into account the (kinematic) viscosity v of the flowing fluid (equation 6):

$$\dot{V} = v * g ( Kij , norm )$$

When using a linear relationship of the transfer factors, this procedure does not achieve any advantage; it only performs a superfluous calculation (division by the kinematic viscosity and subsequent multiplication by the kinematic viscosity cancel each other out exactly). However, when using the non-linear relationship g in the normalized transfer factors, the procedure is advantageous.

In a further development of the aforementioned design of the method, it is provided that the non-linear function is formed by an artificial neural network with an input layer with at least a number of input neurons corresponding to the number of transfer factors used as input variables, with an output layer with at least one output neuron for outputting at least the volume flow of the medium as an output variable and with at least one intermediate layer with at least two neurons, in particular wherein the artificial neural network is trained with calibration data. The calibration data can originate from real calibration measurements, but they can also originate from corresponding numerical simulations if these are available.

According to a preferred further development of the method, only a certain number or a certain percentage of the highest-value transmission factors are used to determine the volume flow or only transmission factors that are above a certain limit value are used to determine the volume flow, wherein the limit value is, in particular, a certain percentage value of the value range of all transmission factors. The above-mentioned procedures are generally suitable for improving the signal-to-noise ratio, as transmission factors with a high noise component can be disregarded.

The method for operating a magnetic-inductive flowmeter can also be designed in such a way that the influence of some excitation currents on some induced measurement voltages is desired and the influence on other measurement voltages is undesirable and unintended. In this case, those transmission factors that describe a dependency to be taken into account between the excitation current and the induced measurement voltage would be included in the calculation of the volume flow, whereas transmission factors that describe undesirable relationships would be disregarded or not calculated at all.

In a preferred design of the method, n magnetic field devices are energized with n excitation currents to determine the volume flow, m measurement voltages are captured and m*n transfer factors are determined. This results in a system of equations with m*n transfer factors, as already described using equation 2. Each line of the system of equations has n unknowns, namely n transfer factors. For the first measuring voltage, for example, the situation is as follows (equation 7):

$$U 1 = K 11 * I 1 + K 12 * I 2 + … + K ln * In$$

Equation 7 is underdetermined with a set of excitation currents I1, I2, . . . , In, the transfer factors K11, . . . , K1n cannot be clearly determined with a set of excitation currents. Rather, n measurement cycles with n linearly independent excitation current vectors Iv1, . . . , Ivn are required for an unambiguous determination. In a preferred design of the aforementioned method, it is therefore provided that the magnetic field devices are energized in n successive measurement cycles with n linearly independent excitation current vectors Iv1, Iv2, . . . , Ivn, each with the excitation currents I1, I2, . . . , In, wherein in particular in one measurement cycle the magnetic field devices which have a non-zero excitation current are energized simultaneously. In each of the n measurement cycles, the resulting induced measurement voltages are also captured. In this way, n equations with n unknowns are obtained for each measurement voltage, resulting in a solvable system of equations for the n unknowns, i.e. the n unknown transmission factors for one measurement voltage in each case. The induced measurement voltages obtained in each measurement cycle each form a measurement voltage vector Uv1, Uv2, . . . , Uvn. In total, the excitation current vectors Iv1, Iv2, . . . , Ivn form an excitation current matrix Iv with the dimension n*n and the measurement voltage vectors Uv1, Uv2, . . . , Uvn form the measurement voltage matrix Uv with the dimension m*n. The relationship is therefore as follows, wherein the dimensions of the variables are placed in round brackets (equation 8):

$$U ( m * n ) = K ( m * n ) * I ( n * n ) .$$

Expressed with the excitation current vectors Ivi described above and the measurement voltage vectors Uvi, the result is (equation 9):

$$[ Uv 1 , Uv 2 , … , Uvn ] = K ( m * n ) * [ Iv 1 , Iv 2 , … , Inv ] .$$

In the general case, the inverse of the excitation current matrix must be formed to solve the system of equations, wherein right multiplication of equation 6 with the inverse of the excitation current matrix I then immediately results in the transfer factor matrix K with the transfer factors Kij (equation 10):

$$U * I - 1 = K * I * I - 1 = K .$$

In one design of the method, it is intended that in one measurement cycle exactly one excitation current is different from zero (all other excitation currents are therefore equal to zero), so that n transfer factors can be determined immediately in one measurement cycle. This procedure means that there is no need to solve a system of equations or calculate the inverse of the excitation current matrix. However, several excitation currents cannot be used simultaneously, which may have a negative effect on the signal-to-noise ratio.

In a preferred design of the method, optimum filtering of the measurement voltages is implemented by initially selecting the excitation currents in the excitation current vectors in such a way that an excitation current matrix formed from the excitation current vectors as row vectors or column vectors is orthogonal, i.e. invertible, in particular wherein the measurement voltages captured in the measurement cycles are cross-correlated with the excitation currents (matched filter). This measure can also improve the signal-to-noise ratio.

There are various ways of finding excitation schemes for the excitation currents Ij so that linearly independent excitation current vectors Ivj and thus invertible excitation current matrices I result.

In this context, a preferred design of the method for operating a magnetic-inductive flowmeter provides that the excitation currents I1, I2, . . . , In in the excitation current vectors Ivj are selected such that an excitation current matrix I formed from the excitation current vectors Ivj as row vectors or column vectors is orthogonal (and thus necessarily invertible), wherein the excitation current matrix I is obtained by a Householder transformation of a freely selected excitation current vector Ivi. In particular, preference is given to those resulting excitation current matrices I that have a low variance in the values of the matrix elements. This criterion is used because very different high excitation currents lead to a poorer overall signal-to-noise ratio of the result than is the case when using excitation currents with a similarly high amplitude. From a numerical point of view, there is a correlation here with the condition of the excitation current matrix.

In a preferred design of the method, an excitation scheme is used that implements binary excitation: The non-zero excitation currents in the excitation current vectors have an equal amplitude, in particular the maximum amplitudes provided in the operation of the magnetic-inductive flowmeter are used in order to achieve an optimum signal-to-noise ratio. With such excitation current vectors, orthogonal excitation current matrices can only be implemented with an even number of excitation currents.

In another preferred design of binary excitation, a power-of-two excitation current is used. In this case, an orthogonal excitation current matrix I, which fulfills the orthogonality condition, is systematically generated by using the code tree of an orthogonal variable spreading factor (OVSF) code. First, an OVSF code tree with the desired length n (number−power of two−of excitation currents) is generated. Then the n different binary OVSF codes with the elements {−1, +1} are arranged column by column (or row by row) at the branches of the code tree as elements of a matrix with the size (m*n). This is done with one code after the other in such a way that (after multiplying the matrix by a constant current) a symmetrical excitation current matrix I is obtained. A binary and orthogonal excitation current matrix I, as derived above, is a preferred implementation for the proposed simultaneous excitation of the magnetic field devices of the magnetic-inductive flowmeter. The optimization of the signal-to-noise ratio by simultaneous excitation of several magnetic field devices (or even all magnetic field devices) with the same amplitude of the excitation current is also advantageous here.

Since orthogonal excitation current matrices I are mentioned often in the above embodiments, it is finally pointed out again that non-orthogonal excitation current matrices can of course also be used, the matrices only have to be invertible. However, the embodiments presented represent optimal implementations in various respects.

In reality, the measured voltages Ui captured by the measuring electrodes are not only based on the induction effect of the magnetic field, but also include electrochemical voltage components Uch,i and noise components Un,i. Only the electrochemical voltage components Uch,i should be taken into account here. If this is done, then equation 2 reads as follows in an extension (equation 11):

$$U = K * I + Uch .$$

Uch is the electrochemical voltage vector of the electrochemical voltages Uch,i at the measuring electrodes that capture the measuring voltage Ui. These electrochemical voltages vary only very slowly over time, at least in comparison to the measuring frequencies implemented with magnetic-inductive flowmeters.

In an advantageous design of the method, the electrochemical voltage components (Uch1, Uch2, . . . , Uchn) at the measurement voltages (U1, U2, . . . , Un) are determined and adjusted measurement voltages U′ are calculated by subtracting the electrochemical voltage components (Uch1, Uch2, . . . , Uchn) from the measured voltages (U1, U2, . . . , Un) and wherein the method described above is then performed with the adjusted measured voltages, i.e. (equation 12):

$${U}^{′} = U - Uch = K * I .$$

The electrochemical voltage components Uch can be determined via separate measurements, for example via a subtraction measurement assuming invariable electrochemical voltages between the times of the measurements.

The object derived above is also achieved by the magnetic-inductive flowmeter described several times herein, wherein the magnetic-inductive flowmeter, in particular the control and evaluation unit of the magnetic-inductive flowmeter, is designed such that the method described above is performed during operation of the magnetic-inductive flowmeter.

A preferred design of the magnetic-inductive flowmeter is characterized in that at least as many excitation current sources are present as different excitation currents are required to act on the magnetic field devices, so that an excitation current can be applied to the magnetic field devices simultaneously. This design has the advantage that a measurement cycle, i.e. the excitation of the magnetic field devices with an excitation current vector, can be carried out in the shortest possible time. This also enables the best possible signal-to-noise ratio to be achieved.

In an alternative design of the magnetic-inductive flowmeter, there are fewer excitation current sources than the number of different excitation currents required to excite the magnetic field devices. The excitation current sources are switched sequentially to the magnetic field devices using a demultiplexer arrangement so that the magnetic field devices can be energized with an excitation current one after the other or partly simultaneously and partly one after the other. In this design, fewer excitation current sources are required than in the embodiment shown above, but more time is required to perform the excitation schemes in the form of the various excitation current vectors.

In an advantageous design of the magnetic-inductive flowmeter, there are at least as many voltage measuring devices as there are different measuring voltages to be captured, so that the measuring voltages can be captured simultaneously. Here too, the advantage lies in the fast capture of all measured voltages with a high level of technical equipment complexity.

As an alternative to the previous design, fewer voltage measuring devices are implemented in the magnetic-inductive flowmeter than there are different measuring voltages, and the voltage measuring devices are connected sequentially to the measuring electrodes using a multiplexer arrangement, so that the measuring voltages can be detected one after the other or partly simultaneously and partly one after the other. This considerably reduces the technical complexity of the device and thus also the costs caused by the circuitry implementation.

### BRIEF DESCRIPTION OF THE DRAWINGS

In detail, there is now a large number of possibilities for designing and further developing the method according to the invention for operating a magnetic-inductive flowmeter and the corresponding magnetic-inductive flowmeter. Reference is made to the following description of embodiments in conjunction with the drawings.

FIG. 1 schematically illustrates a method for operating a magnetic-inductive flowmeter and a corresponding magnetic-inductive flowmeter with two magnetic field devices and two measuring voltages to be captured.

FIG. 2. schematically illustrates a method for operating a magnetic-inductive flowmeter and a corresponding magnetic-inductive flowmeter with three magnetic field devices and three measuring voltages to be captured.

FIG. 3 schematically illustrates a method for operating a magnetic-inductive flowmeter and a corresponding magnetic-inductive flowmeter with a device for one-step excitation and measurement in one measuring cycle.

FIG. 4 schematically illustrates a method for operating a magnetic-inductive flowmeter and a corresponding magnetic-inductive flowmeter with a device for multi-step excitation and measurement in a measuring cycle.

### DETAILED DESCRIPTION

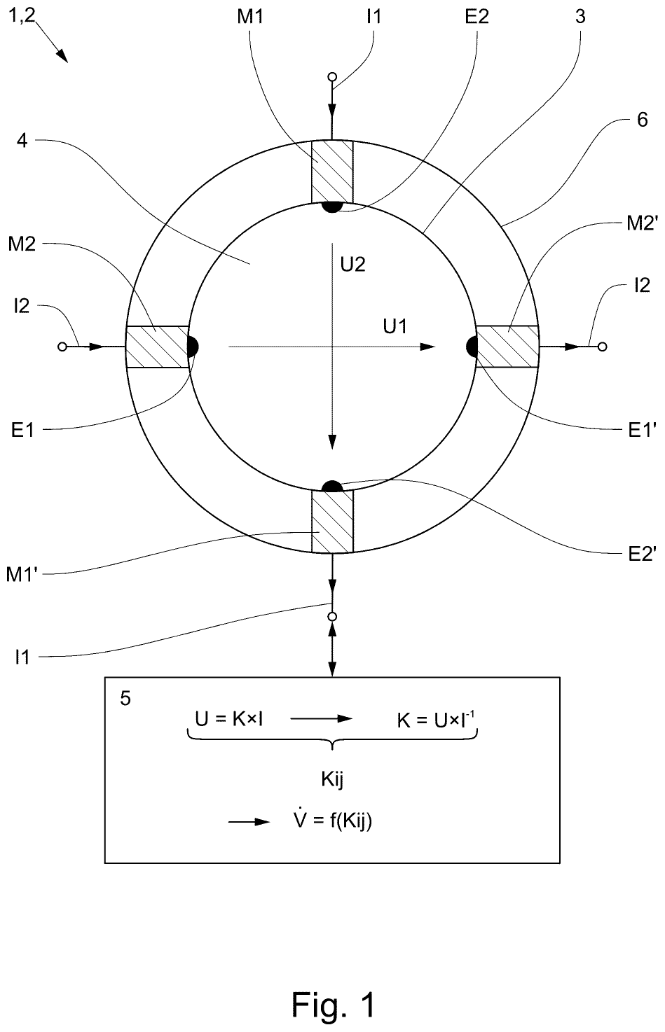

FIGS. 1 to 4 show various aspects of a method 1 for operating a magnetic-inductive flowmeter 2 and corresponding magnetic-inductive flowmeters 2. In the figures, both numbers and letters are used as reference signs. For the most part, the letters only have the character of reference signs, but they make it much easier to understand and establish the connection between the description and the drawing. In some cases, the reference signs also have the character of formula signs, wherein the formula signs, for example in the claims, are helpful for understanding the claims, but they are not necessary for understanding. In this respect, the letter reference signs as well as formula signs in the claims are placed in brackets and are also treated as reference signs in the following description of the figures.

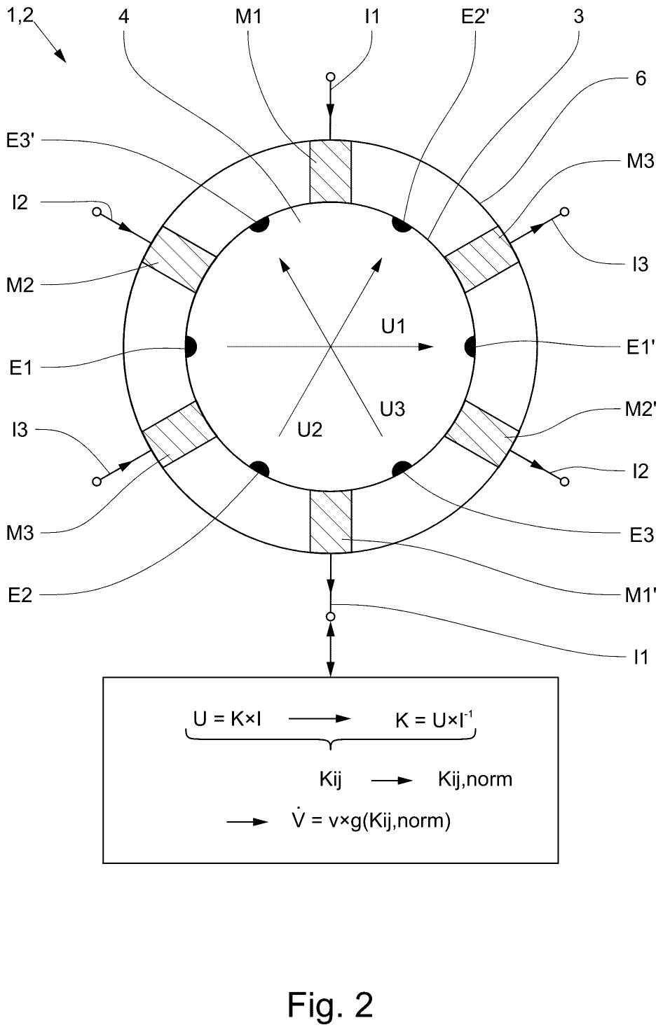

FIGS. 1 and 2 schematically show structural components of the magnetic-inductive flowmeters considered here. The flowmeters 2 have a measuring tube 3 for guiding an electrically conductive medium 4. There are a plurality of magnetic field devices Mi, Mi′, which can be energized separately with excitation currents Ii, for generating at least one magnetic field passing through the measuring tube 3 at least partially perpendicular to the direction of flow of the medium 4. Furthermore, a plurality of measuring electrodes Ei, Ei′ is implemented for capturing a plurality m of measuring voltages Ui induced in the medium 4. It is shown in all figures that the magnetic-inductive flowmeters 2 also each comprise a control and evaluation unit 5 which, among other things, is used to generate the magnetic field by energizing at least one of the magnetic field devices Mi, Mi′ and to calculate the volumetric flow rate of the medium 4 through the measuring tube 3.

The magnetic-inductive flowmeter 2 according to FIG. 1 has two magnetic field devices M1, M1′ and M2, M2′, each consisting of a pair of coils facing each other on the circumference of the measuring tube 3. It is indicated that an identical excitation current I1 is applied to the pair of coils M1, M1′, which is why the pair of coils represents a single magnetic field device M1, M1′. The same applies analogously to the magnetic field device M2, M2′ with the coils M2 and M2′ opposite each other on the circumference of the measuring tube 3, which are also subjected to an identical excitation current I2 and are therefore to be regarded as a single magnetic field device M2, M2′. The magnetic circuit or magnetic circuits are specifically closed with the aid of an outer ring 6. The magnetic field generated by the magnetic field devices Mi, Mi′ thus runs between the parts of the magnetic field device Mi, Mi′ in the interior of the measuring tube 3 and is then closed via the outer ring 6. Other solutions are easily conceivable, for example with segmented elements for closing magnetic circuits that are independent of each other, but this is not relevant to the present invention. The magnetic-inductive flowmeter according to FIG. 1 has 4 measuring electrodes E1, E1′, E2, E2′. In each case, 2 electrodes are used to capture an induced measuring voltage. The electrodes E1, E1′ are used to capture the measurement voltage U1, and the electrodes E2, E2′ are used to capture the measurement voltage U2.

The method 1 considered here for operating the magnetic-inductive flowmeter 2 and the correspondingly designed magnetic-inductive flowmeter 2, which performs said method 1 during operation, are characterized in that a plurality of the magnetic field devices Mi, Mi′ are subjected to a plurality n of excitation currents Ii, that a plurality m of measurement voltages Ui are captured and that a plurality of flow-dependent transmission factors Kij are determined from the excitation currents Ii and the measurement voltages Ui caused by the excitation currents Ii. Here, a transmission factor Kij is the ratio of the proportion of a measuring voltage Ui caused by an excitation current Ij to the magnitude of this excitation current Ij. Finally, the volume flow (V-point in the figures) of the medium 4 in the measuring tube 3 is calculated from a plurality of the determined flow-dependent transmission factors Kij.

For the embodiment of FIG. 1 with two magnetic field devices M1, M1′ and M2, M2′, which are energized by two separate excitation currents I1, I2, and in which two measurement voltages U1, U2 are measurement-based, there are four correlations, namely the influence of the excitation current I1 on the measurement voltages U1 and U2 and also the effects of the excitation current I2 on the measurement voltages U1 and U2. Expressed as an equation, this is the relationship (similar to that shown in equation 1 above), equation 13:

$$U 1 = K 11 * I 1 + K 12 * I 2$$

$$U 2 = K 21 * I 1 + K 22 * I 2.$$

This clearly expresses the actual situation that both excitation currents I1 and I2 make a contribution to the measurement voltages U1 and U2. This contribution depends constructively on the implementation of the magnetic-inductive flowmeter 2, i.e. on the arrangement of the magnetic field devices Mi to the measuring electrodes Ei, but the contribution also depends on the actual flow conditions in the measuring tube 3 of the magnetic-inductive flowmeter 2, locally weighted by the magnetic field generated by the respective excitation current I1 in the measuring tube volume and by the relevant position of the measuring electrodes Mi. The transfer factors Kij thus support extensive physical information about the flow in the measuring tube 3.

While in the prior art only the measuring voltages U1, U2 are used to determine the volume flow through the measuring tube 3, not only two but four pieces of information, namely the four transmission factors K11, K12, K21, K22, are available for determining the volume flow according to the method 1 presented here, which describe the flow events in the measuring tube 3 in a much more differentiated manner. Since the excitation currents I1, I2 are specified, i.e. are within the sphere of influence of the operator of the magnetic-inductive flowmeter 2, and the measurement voltages U1, U2 are by definition measured variables, the transmission factors Kij can, in principle, be determined. To do this, a sufficient number of (independent) measurements must be performed with corresponding excitation currents so that the transmission factors Kij can be clearly determined. The four pieces of flow information Kij in the example according to FIG. 1 are used according to the invention to calculate the volume flow. In the prior art, the volume flow would only be calculated using the two measured voltages U1, U2. The diversity of information opens up the possibility of determining the volume flow much more robustly and accurately, especially in the presence of changes in the flow profile.

The method 1 described in its basic features for operating a magnetic-inductive flowmeter 2 can also be applied to the design of a magnetic-inductive flowmeter 2 shown in FIG. 2, where a total of three separately energizable magnetic field devices M1 and M1′, M2 and M2′, M3 and M3′ are implemented. Here too, one magnetic field device Mi, Mi′ consists of two coils located opposite each other on the circumference of the measuring tube 3, which are energized with an identical excitation current I1, I2, I3. The measuring electrodes Ei, Ei′ are arranged offset to the positions of the magnetic field devices Mi, Mi′. The measuring electrodes E1, E1′ pick up the measuring voltage U1, the measuring electrodes E2, E2′ pick up the measuring voltage U2 and the measuring electrodes E3, E3′ pick up the measuring voltage U3. The three excitation currents I1, I2, I3 each influence the measuring voltages U1, U2, U3. Expressed as an equation, the following relationship exists (equation):

$$U 1 = K 11 * I 1 + K 12 * I 2 + K 13 * I 3$$

$$U 2 = K 21 * I 1 + K 22 * I 2 + K 23 * I 3$$

$$U 3 = K 31 * I 1 + K 22 * I 2 + K 33 * I 3.$$

In this example, there are therefore nine correlations in the form of the transfer factors Kij between the excitation currents Ii and the measuring voltages Ui. The volume flow through the measuring tube 3 is calculated here with a plurality of the transfer factors Kij, i.e. with a maximum of nine transfer factors, which describe the fluidic conditions in the measuring tube 3 of the magnetic-inductive flowmeter 2. Here, too, there is a clear informative advantage over the exclusive use of the measuring voltages U1, U2 and U3.

At this point, it should be noted that significantly more magnetic field devices Mi could be implemented with the six coils M1, M1′, M2, M2′ and M3, M3′ than are indicated in this embodiment. The decisive factor is the ability to energize the arrangements with separate excitation currents Ii. A further magnetic field device could, for example, consist of the configuration of the coils M1, M2 and M1′, M2′, which could be energized with a common excitation current Ii and thus generate an intermediate magnetic field with a main direction between the electrodes E3, E3′. In the case of the magnetic field devices Mi, it is therefore important that they can be energized separately.

In the embodiments shown, several of the plurality of magnetic field devices Mi are simultaneously energized with a plurality of the excitation currents Ii. The advantage of this is that the proportion of the useful signal in the measurement voltages Ui is stronger in relation to possible interfering influences, such as electrochemical voltages and noise voltages that are always present. As a result, the noise/interference ratio of the measurement is improved. It is important to ensure that the system as a whole is operated in a linear range, in particular that the magnetic circuit system does not reach a saturation range.

In the embodiment shown in FIG. 1, the volume flow of the medium 4 is calculated from a linear combination of several of the flow-dependent transfer factors Kij, wherein the transfer factors Kij are weighted by weighting factors Wij, see equation 3. This allows account to be taken of the fact that the excitation current I1 makes a more significant contribution to the measurement voltage U1 than to the measurement voltage U2. The same applies to the excitation current I2, which is more significant for the measurement voltage U2 than for the measurement voltage U1.

In the embodiment according to FIG. 2, the volume flow of the medium 4 is calculated with a non-linear function f in several of the flow-dependent transfer factors Kij, wherein the transfer factors Kij in the non-linear function are weighted by weighting factors Wij, see equation 4. In a further development of the embodiment according to FIG. 2, it is additionally implemented that normalized transfer factors Kij are calculated using the known or measured kinematic viscosity v of the medium 4. The normalized transfer factors (Kij,norm=Kij/v)) are mapped non-linearly using a non-linear function g to an estimated value for a total Reynolds number, wherein the volume flow is then calculated using the function g, taking into account the kinematic viscosity v of the flowing medium (see equation 6 and FIG. 2).

In the embodiment of the method according to FIG. 2, the method 1 implements that only a determined percentage of the highest transmission factors Kij is used to determine the volume flow. This prevents transmission factors with a potentially poor signal-to-noise ratio from being included in the calculation.

In any case, the embodiments according to FIGS. 1 and 2 have in common that the plurality of magnetic field devices M1, M1′, M2, M2′, M3, M3′, to which a plurality of excitation currents I1, I2, I3 are applied, also generate differently oriented magnetic fields in the measuring tube 3. This also applies in the same way to the several measuring voltages U1, U2, U3 captured by the plurality of measuring electrodes E1, E1′, E2, E2′, E3, E3′, which are measured along differently oriented measuring paths within the measuring tube 3, wherein a measuring path is essentially determined by the imaginary connecting line between the measuring electrodes E1 and E1′, E2 and E2, E3 and E3′ involved in the measurement (see arrows at the designators U1, U2, U3).

The embodiments shown also have in common that more transfer factors Kij are determined than measured voltages U1, U2, U3 have been captured, and that more transfer factors Kij are used to calculate the volumetric flow than measured voltages U1, U2, U3 have been captured. In this case, there is a clear gain in information compared to the known use of the measured voltages alone.

As is readily apparent, FIGS. 1 to 4 are schematic representations of principles and not technical or even circuit engineering drawings. In order to keep the illustrations simple, only the necessary relationships are indicated. In this respect, closed circuits have not been shown in some cases. For example, in the case of the magnetic field devices Mi, Mi′, it is only indicated that an excitation current Ii is applied to them. It goes without saying that this requires a power electronic circuit which is part of the control and evaluation unit 5 or at least is controlled by it. It is also not shown, for example, that the coils Mi, Mi′ are most likely galvanically coupled to each other in reality and that the current I1 is then naturally only generated by a single current source. The same applies to schematically depicted voltage measurements and outputs of current sources. In both cases, two electrical terminals are, of course, required in principle (measurement of two potentials, implementation of a current loop), which are not explicitly shown in the figures and are not necessary for understanding.

The method 1 for the magnetic-inductive flowmeter 2 according to FIG. 1 calculates the volume flow of the medium 4 with a non-linear function f in several of the flow-dependent transmission factors Kij.

The method 1 in the magnetic-inductive flowmeter 2 according to FIG. 2 calculates the volume flow of the medium 4 by means of normalized transfer factors Kij, norm using the known or measured kinematic viscosity v of the medium 4. The normalized transfer factors (Kij,norm=Kij/v) are mapped nonlinearly to an estimated value for a total Reynolds number using a nonlinear function g, wherein the volume flow is then calculated using the function g, taking into account the kinematic viscosity v of the flowing medium 4.

Of overall interest is how the transfer factors Kij are determined. There are various approaches to this, which have different advantages and are optimal in various respects.

In general, it can be said that to determine the volume flow, n magnetic field devices Mi, Mi′ are energized and m measurement voltages are captured and m*n transmission factors Kij are determined. As already explained, the magnetic-inductive flowmeter 2 according to FIG. 1 has two magnetic field devices M1, M1′, M2, M2′ to which two excitation currents I1, I2 are applied, and two measuring voltages U1, U2 are captured so that four transmission factors K11, K12, K21, K22 can be determined. In the embodiment shown in FIG. 2, there are three magnetic field devices M1, M1′, M2, M2′, M3, M3′ to which three excitation currents I1, I2 are applied, and three measurement voltages U1, U2 are captured, so that nine transmission factors K11, K12, K21, K22 can be determined. That the number of excitation currents and the number of measurement voltages are the same in both examples is a coincidence; embodiments in which the number of excitation currents and the number of measurement voltages differ from one another are just as conceivable. In any case, however, the relationships according to equations I3 and 14 (or more generally the relationship according to equation 2) must be used to determine the transfer factors Kij.

If the magnetic field devices Mi, Mi′ are only subjected once to a combination of excitation currents I1, I2, . . . , In, the aforementioned systems of equations are underdetermined, with the result that the transmission factors Kij cannot be determined unambiguously. Several measurements must therefore be performed in order to be able to determine the transfer factors Kij unambiguously.

In the embodiments of the method, the methods 1 are designed in such a way that the magnetic field devices Mi, Mi′ are energized in n successive measurement cycles with n linearly independent excitation current vectors Iv1, Iv2, . . . , Ivn, each with the excitation currents I1, I2, . . . , In. Each excitation current vector Iv1, Iv2, . . . , Ivn therefore comprises a combination of the excitation currents I1, I2, . . . , In. If n measurement cycles with n excitation combinations of the excitation currents of the magnetic field devices Mi, Mi′ and with m measurements of the measurement voltages have been carried out, the transmission factors Kij can be clearly determined, see the general explanations that led to equations 8 and 9.

In the embodiment shown in FIG. 1, the magnetic field devices M1, M1′ and M2, M2′, which have a non-zero excitation current I1, I2, are energized simultaneously in a measurement cycle. This has the advantage that the n=2 measurement cycles are completed very quickly, but two current sources that can be operated separately and simultaneously are then also required. A further advantage is that the overall signal-to-noise ratio of the measurement is improved when several excitation currents are excited simultaneously.

Method 1 is implemented differently in the embodiment of the method shown in FIG. 2. Here, exactly one excitation current Ii is different from zero in one measurement cycle, so that m=3 transmission factors Kij can be determined immediately in one measurement cycle. If, for example, only the excitation current I1 is not equal to 0, then there is also only one effect of the excitation current I1 on the measurement voltages U1, U2, U3, so that the transfer factors K11, K21, K31 can be determined directly. This means that no system of equations actually needs to be solved. Another advantage is that only a single excitation current source needs to be implemented, which is then switched to the corresponding magnetic field device in each measurement cycle by means of a demultiplexer arrangement. In this case, there is also no loss of time associated with the use of fewer excitation current sources than magnetic field devices.

In the embodiment according to FIG. 2, it is further implemented that the non-zero excitation currents I1, I2, I3 in the excitation current vectors have the same amplitude, namely at the level of the maximum amplitude provided during operation of the magnetic-inductive flowmeter. In this design, the only required excitation current source does not even have to be a controllable current source; it can be a fixed current source, which reduces the circuitry and also the economic effort required to implement this solution.

In all embodiments, the electrochemical voltage components Uchi arising at the measuring electrodes Ei are determined at the measuring voltages Ui. Adjusted measurement voltages Ui′ are then calculated by subtracting the electrochemical voltage components Uch1 from the measurement voltages Ui.

The method 1 described above is then performed with the adjusted measured voltages Ui′ instead of the measured voltages Ui.

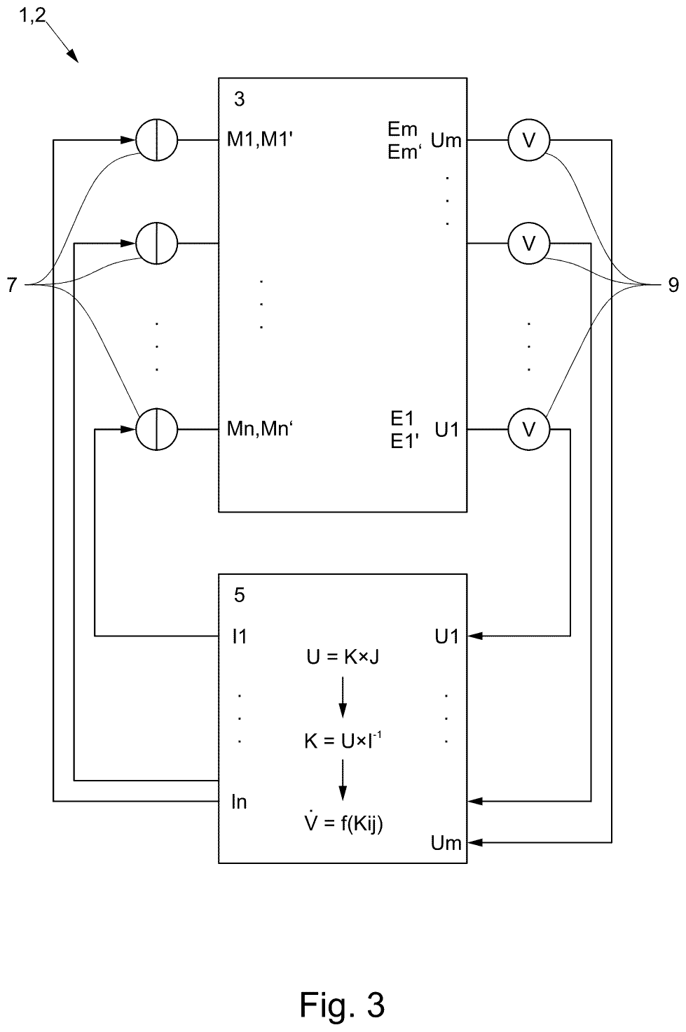

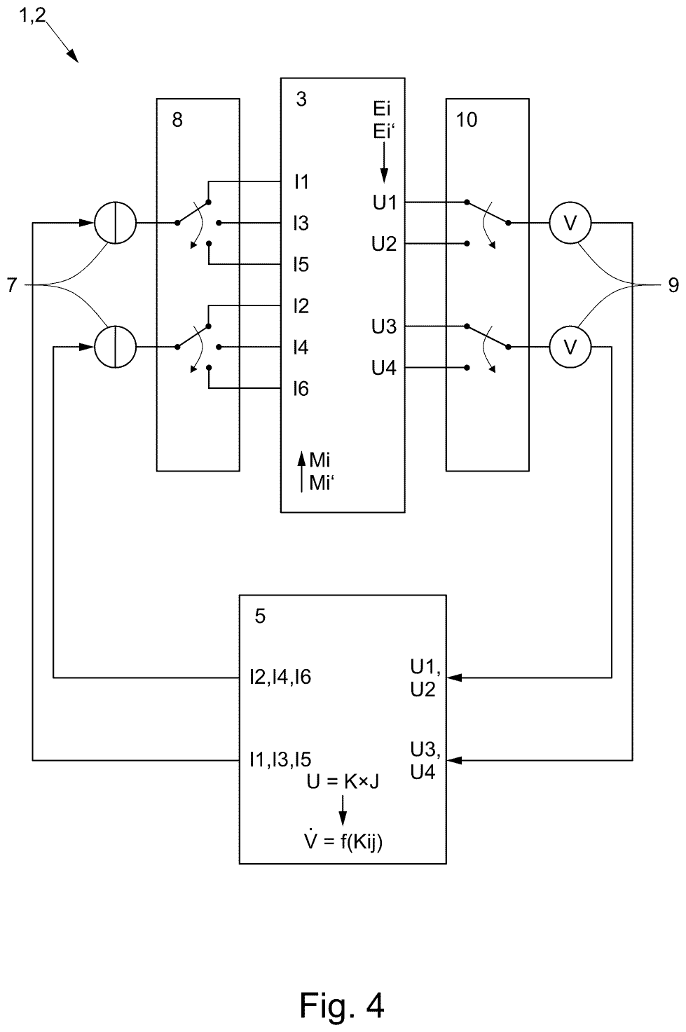

FIGS. 3 and 4 once again address an aspect which has already been indicated with regard to the embodiments in FIGS. 1 and 2, but which is addressed here once again centrally.

In the magnetic-inductive flowmeter 2 in FIG. 3, there are as many excitation current sources 7 as there are different excitation currents Ii required to energize the magnetic field devices Mi, Mi′, so that the magnetic field devices Mi, Mi′ can be and are simultaneously energized with an excitation current Ii. The advantages here are fast measurement cycles and a high achievable signal-to-noise ratio. However, the implementation is complex in terms of circuitry. In addition, the magnetic-inductive flowmeter 2 according to FIG. 3 has as many voltage measuring devices 9 as there are different measuring voltages Ui to be captured, so that the measuring voltages Ui can be captured simultaneously. The advantage of this is fast measuring cycles but high circuit complexity. The magnetic-inductive flowmeter according to FIG. 3 is designed for high measuring rates with a high achievable signal-to-noise ratio.

This differs from the situation with the magnetic-inductive flowmeter 2 shown in FIG. 4, where there are fewer excitation current sources 7—namely only two—than the various excitation currents I1, I2, I3, I4, I5, I6 required to energize the six magnetic field devices M1, M1′, . . . , M6, M6′. The excitation current sources 7 are sequentially connected to the magnetic field devices Mi, Mi′ with a demultiplexer arrangement 8, so that the magnetic field devices Mi, Mi′ can be and are energized with an excitation current I1 partly simultaneously and partly in succession.

In addition, the magnetic-inductive flowmeter 2 according to FIG. 4 also has fewer voltage measuring devices 9—namely only two—than there are different measuring voltages U1, U2, U3, U4. The voltage measuring devices 9 are connected sequentially to the measuring electrodes Ei, Ei′ using a multiplexer arrangement 10, so that the measuring voltages Ui can be and are captured partly simultaneously and partly in succession. With the magnetic-inductive flowmeter according to FIG. 4, the focus is on reduced circuitry and costs at the expense of slower achievable measuring rates and possibly also a poorer signal-to-noise ratio.

Of course, the measures do not have to be implemented together. It is therefore quite possible, for example, to work with fewer excitation current sources than magnetic field devices, but to provide as many voltage measuring devices as there are measuring voltages to be captured. The advantages and disadvantages must be weighed against one another in each specific case.

1. A method for operating a magnetic-inductive flowmeter, having a measuring tube for guiding an electrically conductive medium, having a plurality of magnetic field devices, which can be energized separately with excitation currents, for generating at least one magnetic field passing through the measuring tube at least partially perpendicular to the direction of flow of the medium, with a plurality of measuring electrodes for capturing a plurality of measuring voltages induced in the medium, and with a control and evaluation unit for generating the magnetic field by energizing at least one of the magnetic field devices and for calculating the volume flow of the medium through the measuring tube, the method comprising:
applying a plurality of excitation currents to the plurality of the magnetic field devices;
capturing a plurality of measurement voltages is captured;
determining a plurality of flow-dependent transfer factors from the excitation currents and the measurement voltages caused by the excitation currents, wherein a each of the transfer factors is a ratio of a proportion of a measurement voltage caused by an excitation current to a magnitude of this the excitation current; and
calculating the volume flow of the medium from the transfer factors.

2. The method according to claim 1, wherein several of the plurality of magnetic field devices are simultaneously subjected to the plurality of excitation currents.

3. The method according to claim 1, wherein the volume flow of the medium is calculated from a linear combination of the transfer factors; and
wherein the transfer factors are weighted by weighting factors.

4. The method according to claim 1, wherein the volume flow of the medium is calculated using a first non-linear function in the transfer factors; and
wherein the transfer factors in the non-linear function are weighted by weighting factors.

5. The method according to claim 4, wherein normalized transfer factors are calculated using a known or measured kinematic viscosity of the medium;
wherein the normalized transfer factors are mapped non-linearly with the aid of a second non-linear function to an estimated value for a total Reynolds number; and
wherein the volume flow is then calculated using the function, taking into account the kinematic viscosity of the flowing medium.

6. The method according to claim 4, wherein the first non-linear function and the second non-linear function are formed by an artificial neural network including:
an input layer with at least a number of input neurons corresponding to a number of the transfer factors used as input variables;
an output layer with at least one output neuron for outputting at least the volume flow of the medium as output variable; and
at least one intermediate layer with at least two neurons; and wherein the artificial neural network is trained with calibration data.

7. The method according to claim 1, wherein only a determined number or a determined percentage of the transfer factors which are of a highest order is used to determine the volume flow, or that only transfer factors which are above a determined percentage value of the value range of all transfer factors are used to determine the volume flow.

8. The method according to claim 1, wherein n magnetic field devices are energized to determine the volume flow and m measurement voltages are captured and m*n transfer factors are determined.

9. The method according to claim 8, wherein in n measurement cycles carried out in succession with n linearly independent excitation current vectors, each with the excitation currents are applied to the magnetic field devices; and
wherein the magnetic field devices which have a non-zero excitation current are applied simultaneously in a measurement cycle.

10. The method according to claim 9, wherein in one measurement cycle exactly one excitation current is different from zero, so that m transfer factors can be determined immediately in one measurement cycle.

11. The method according to claim 9, wherein the excitation currents in the excitation current vectors are selected in such a way that one of the excitation current vectors as row vectors or column vectors is orthogonal; and
wherein the measurement voltages captured in the measurement cycles are cross-correlated with the excitation currents in order to implement an optimal filtering.

12. The method according to claim 9, wherein the excitation currents in the excitation current vectors are selected such that an excitation current matrix formed from the excitation current vectors as row vectors or column vectors is orthogonal;
wherein the excitation current matrix is obtained by a Householder transformation of a freely selected excitation current vector; and
wherein preference is given to those excitation current matrices which have a low variance in the values of the matrix elements.

13. The method according to claim 9, wherein the non-zero excitation currents in the excitation current vectors have the same amplitude, in particular and have the maximum amplitudes provided for in the operation of the magnetic-inductive flowmeter.

14. The method according to claim 1, wherein the electrochemical voltage components at the measurement voltages are determined and adjusted measurement voltages are calculated by subtracting the electrochemical voltage components from the measured voltages; and
wherein the method is performed with the adjusted measured voltages.

15. A magnetic-inductive flowmeter, comprising:
a measuring tube for guiding an electrically conductive medium;
a plurality of magnetic field devices which can be energized separately with excitation currents for generating at least one magnetic field passing through the measuring tube at least partially perpendicular to the direction of flow of the medium;
a plurality of measuring electrodes for capturing a plurality of measuring voltages induced in the medium; and
a control and evaluation unit for generating the magnetic field by energizing at least one of the magnetic field devices and for calculating the volume flow of the medium through the measuring tube;
that wherein the control and evaluation unit is designed such that the magnetic-inductive flowmeter performs a method during operation, the method including the following steps:
applying a plurality of excitation currents to the plurality of the magnetic field devices;
capturing a plurality of measurement voltages;
determining a plurality of flow-dependent transfer factors from the excitation currents and the measurement voltages caused by the excitation currents, wherein each of the transfer factors is a ratio of a proportion of a measurement voltage caused by an excitation current to a magnitude of the excitation current; and
calculating the volume flow of the medium from the transfer factors.

16. The magnetic-inductive flowmeter according to claim 15, wherein at least as many excitation current sources are present as different excitation currents are required to act on the magnetic field devices, so that the magnetic field devices can be acted on simultaneously with an excitation current.

17. The magnetic-inductive flowmeter according to claim 15, wherein fewer excitation current sources are present than different excitation currents are required to act on the magnetic field devices; and
wherein the excitation current sources are sequentially connected to the magnetic field devices by means of a demultiplexer arrangement, so that the magnetic field devices can be subjected to an excitation current in succession in time or partly simultaneously and partly in succession in time.

18. The magnetic-inductive flowmeter according to claim 15, wherein at least as many voltage measuring devices are present as there are different measuring voltages to be captured, so that the measuring voltages can be captured simultaneously.

19. The magnetic-inductive flowmeter according to claim 15, wherein fewer voltage measuring devices are present than different measuring voltages are present; and
wherein the voltage measuring devices are switched sequentially to the measuring electrodes by means of a multiplexer arrangement, so that the measuring voltages can be detected in succession in time or partly simultaneously and partly in succession in time.
